(19) United States
(12) Patent Application Publication
(10) Pub. No.: US 2015/0299498 A1
(43) Pub. Date: Oct. 22, 2015

(54) TRANSPARENT FLUOROPOLYMER COATED FILMS, BUILDING STRUCTURES AND LIQUID FLUOROPOLYMER COATING COMPOSITIONS

(71) Applicant: E I DU PONT DE NEMOURS AND COMPANY, Wilmington, DE (US)

(72) Inventors: NATHANIEL REED SCHWARTZ, Newark, DE (US); Donald Douglas May, Chadds Ford, PA (US)

(21) Appl. No.: 14/676,219

(22) Filed: Apr. 1, 2015

Related U.S. Application Data
(60) Provisional application No. 61/980,898, filed on Apr. 17, 2014.

(51) Int. Cl. C09D 127/16; E04C 2/20; C09D 127/14; E04C 2/02

(52) U.S. Cl. CPC C09D 127/16; E04C 2/02; E04C 2/20; C09D 127/14

(57) ABSTRACT

In a first aspect, a transparent fluoropolymer coated film includes a polymeric substrate film and a fluoropolymer coating on the polymeric substrate film. The fluoropolymer coating includes fluoropolymer selected from homopolymers and copolymers of vinyl fluoride and homopolymers and copolymers of vinylidene fluoride blended with a compatible adhesive polymer and a light stabilizer. The transparent fluoropolymer coated film has a transmission of at least 75 percent in the visible range. In a second aspect, a building structure comprising a transparent fluoropolymer coated film. In a third aspect, a liquid fluoropolymer coating composition includes a fluoropolymer selected from homopolymers and copolymers of vinyl fluoride and homopolymers and copolymers of vinylidene fluoride, a light stabilizer including a combination of a UV absorber and a hindered amine light stabilizer, solvent, a compatible cross-linkable adhesive polymer and a cross-linking agent.

### BACKGROUND INFORMATION

1. Field of the Disclosure

This disclosure relates to transparent fluoropolymer coated films, building structures and liquid fluoropolymer coating compositions.

2. Description of the Related Art

Transparent polymeric films are widely used in outdoor applications for both rigid and flexible structures, such as building structures (e.g., greenhouses, roofing, siding, awnings, windows, etc.), signage, wall coverings, etc., as well as indoor applications where they may be exposed to sunlight. These transparent polymeric films require appropriate physical properties, weatherability and optical properties depending on their intended use. In some cases, a multilayer film may be used, in which each layer contributes some of the required film properties. A wide range of materials are used for transparent polymeric films in outdoor applications, including polyolefins, polyesters, polyethylene/ethylene vinyl acetate composites and acrylic/polycarbonate composites. In some applications, transparent fluoropolymer-based films are used, such as polyvinyl fluoride, polyvinylidene fluoride and ethylene tetrafluoroethylene.

However, the variability of environmental conditions encountered in outdoor applications can prove quite challenging for many polymeric materials. Exposure to sunlight (especially ultraviolet radiation), oxygen, moisture, variable temperatures and other conditions can degrade polymeric materials, affecting their physical and optical properties, as well as their barrier properties. For example, transparent polyolefin films used in greenhouse applications may undergo photo-degradation when exposed to ultraviolet (UV) radiation. Furthermore, exposure to agricultural chemicals in these applications (e.g., herbicides, fungicides, insecticides, etc.) can also degrade polymeric materials.

Fluoropolymer films are useful for outdoor applications such as in photovoltaic (PV) modules, in which film composites of fluoropolymer film and polyester film, which act as a backing sheet for the module, are commonly used. Such composites have traditionally been produced from preformed films of fluoropolymer, such as polyvinyl fluoride (PVF) adhered to polyester film (e.g., polyethylene terephthalate, PET), often in the form of a laminate with a layer of PET film sandwiched between two PVF films. These PV backsheets typically have pigments in them that make them opaque and protect against UV degradation of the film.

In some instances, liquid coating composition can provide thinner fluoropolymer films on polymeric substrates using fewer processing steps as compared to lamination of preformed films. Examples of these systems are described in U.S. Pat. Nos. 7,553,540; 7,981,478; 8,012,542; 8,025,928; 8,048,513; 8,062,744; 8,168,297; and 8,197,933, and U.S. Patent Application Publication Nos. 2011/0086954 and 2012/0116016. Some of these systems include the use of primers on the polymeric substrate to be coated, while other systems disclose fluoropolymer coatings applied directly to unprimed polymeric substrates.

### SUMMARY

In a first aspect, a transparent fluoropolymer coated film includes a polymeric substrate film and a fluoropolymer coating on the polymeric substrate film. The fluoropolymer coating includes fluoropolymer selected from homopolymers and copolymers of vinyl fluoride and homopolymers and copolymers of vinylidene fluoride blended with a compatible adhesive polymer and a light stabilizer. The compatible adhesive polymer includes functional groups selected from carboxylic acid, sulfonic acid, aziridine, amine, isocyanate, melamine, epoxy, hydroxy, anhydride and mixtures thereof. The polymeric substrate film includes functional groups on its surface that interact with the compatible adhesive polymer to promote bonding of the fluoropolymer coating to the polymeric substrate film. The transparent fluoropolymer coated film has a transmission of at least 75 percent in the visible range.

In a second aspect, a building structure includes a transparent fluoropolymer coated film. The transparent fluoropolymer coated film includes a polymeric substrate film and a fluoropolymer coating on the polymeric substrate film. The fluoropolymer coating includes fluoropolymer selected from homopolymers and copolymers of vinyl fluoride and homopolymers and copolymers of vinylidene fluoride blended with a compatible adhesive polymer and a light stabilizer. The compatible adhesive polymer includes functional groups selected from carboxylic acid, sulfonic acid, aziridine, amine, isocyanate, melamine, epoxy, hydroxy, anhydride and mixtures thereof. The polymeric substrate film includes functional groups on its surface that interact with the compatible adhesive polymer to promote bonding of the fluoropolymer coating to the polymeric substrate film. The transparent fluoropolymer coated film has a transmission of at least 75 percent in the visible range.

In a third aspect, a liquid fluoropolymer coating composition includes a fluoropolymer selected from homopolymers and copolymers of vinyl fluoride and homopolymers and copolymers of vinylidene fluoride, a light stabilizer including a combination of a UV absorber and a hindered amine light stabilizer, solvent, a compatible cross-linkable adhesive polymer and a cross-linking agent.

The foregoing general description and the following detailed description are exemplary and explanatory only and are not restrictive of the invention, as defined in the appended claims.

### DETAILED DESCRIPTION

In a first aspect, a transparent fluoropolymer coated film includes a polymeric substrate film and a fluoropolymer coating on the polymeric substrate film. The fluoropolymer coating includes fluoropolymer selected from homopolymers and copolymers of vinyl fluoride and homopolymers and copolymers of vinylidene fluoride blended with a compatible adhesive polymer and a light stabilizer. The compatible adhesive polymer includes functional groups selected from carboxylic acid, sulfonic acid, aziridine, amine, isocyanate, melamine, epoxy, hydroxy, anhydride and mixtures thereof. The polymeric substrate film includes functional groups on its surface that interact with the compatible adhesive polymer to promote bonding of the fluoropolymer coating to the polymeric substrate film. The transparent fluoropolymer coated film has a transmission of at least 75 percent in the visible range.

In one embodiment of the first aspect, the light stabilizer includes a UV absorber, a hindered amine light stabilizer or a combination thereof. In a specific embodiment, the UV absorber includes 2-hydroxyphenyl-s-triazine. In another specific embodiment, the hindered amine light stabilizer includes a combination of bis(1,2,2,6,6-pentamethyl-4-piperidyl) sebacate and methyl 1,2,2,6,6-pentamethyl-4-piperidyl sebacate. In still another specific embodiment, the light stabilizer includes a combination of a UV absorber and a hindered amine light stabilizer, the UV absorber includes 2-hydroxyphenyl-s-triazine, and the hindered amine light stabilizer includes a combination of bis(1,2,2,6,6-pentamethyl-4-piperidyl) sebacate and methyl 1,2,2,6,6-pentamethyl-4-piperidyl sebacate.

In another embodiment of the first aspect, the light stabilizer is present in a range of from about 0.5 to about 15.0 parts per hundred based on fluoropolymer resin solids. In a specific embodiment, the light stabilizer is present in a range of from about 1.0 to about 12.0 parts per hundred based on fluoropolymer resin solids.

In a particular embodiment of the first aspect, wherein the light stabilizer includes a combination of a UV absorber and a hindered amine light stabilizer, a ratio of UV absorber to hindered amine light stabilizer is in a range of from about 1:1 to about 4:1. In a specific embodiment, the ratio of UV absorber to hindered amine light stabilizer is in a range of from about 1.5:1 to about 2:1.

In still another embodiment of the first aspect, the fluoropolymer coating further includes a mixed catalyst.

In a specific embodiment of the first aspect, the transparent fluoropolymer coated film has a transmission of at least 85 percent in the visible range.

In yet another embodiment of the first aspect, the transparent fluoropolymer coated film has a transmission of less than 10 percent at 340 nm after 700 hours of ASTM G155, Cycle 1 weathering testing. In a specific embodiment, the transparent fluoropolymer coated film has a transmission of less than 5 percent at 340 nm after 2400 hours of ASTM G155, Cycle 1 weathering testing.

In still yet another embodiment of the first aspect, the fluoropolymer coating has a dry thickness of from about 2.5 to about 75 μm. In a specific embodiment, the fluoropolymer coating has a dry thickness of from about 6 to about 25 μm.

In another embodiment of the first aspect, the polymeric substrate film has a thickness of from about 12.5 to about 250 μm.

In still another embodiment of the first aspect, the polymeric substrate film is a thermoplastic polyester.

In yet another embodiment of the first aspect, the fluoropolymer coating is a surface layer of the fluoropolymer coated film.

In a second aspect, a building structure includes a transparent fluoropolymer coated film. The transparent fluoropolymer coated film includes a polymeric substrate film and a fluoropolymer coating on the polymeric substrate film. The fluoropolymer coating includes fluoropolymer selected from homopolymers and copolymers of vinyl fluoride and homopolymers blended with a compatible adhesive polymer and a light stabilizer. The compatible adhesive polymer includes functional groups selected from carboxylic acid, sulfonic acid, aziridine, amine, isocyanate, melamine, epoxy, hydroxy, anhydride and mixtures thereof. The polymeric substrate film includes functional groups on its surface that interact with the compatible adhesive polymer to promote bonding of the fluoropolymer coating to the polymeric substrate film. The transparent fluoropolymer coated film has a transmission of at least 75 percent in the visible range.

In a third aspect, a liquid fluoropolymer coating composition includes a fluoropolymer selected from homopolymers and copolymers of vinyl fluoride and homopolymers and copolymers of vinylidene fluoride, a light stabilizer including a combination of a UV absorber and a hindered amine light stabilizer, solvent, a compatible cross-linkable adhesive polymer and a cross-linking agent.

In one embodiment of the third aspect, the UV absorber includes 2-hydroxyphenyl-s-triazine and the hindered amine light stabilizer includes a combination of bis(1,2,2,6,6-pentamethyl-4-piperidyl) sebacate and methyl 1,2,2,6,6-pentamethyl-4-piperidyl sebacate.

Many aspects and embodiments have been described above and are merely exemplary and not limiting. After reading this specification, skilled artisans appreciate that other aspects and embodiments are possible without departing from the scope of the invention. Other features and advantages of the invention will be apparent from the following detailed description, and from the claims.

### Fluoropolymers

Fluoropolymers useful in the fluoropolymer coated film in accordance with one aspect of the invention are selected from homopolymers and copolymers of vinyl fluoride (VF) and homopolymers and copolymers of vinylidene fluoride (VDF). In one embodiment, the fluoropolymer is selected from homopolymers and copolymers of vinyl fluoride comprising at least 60 mole % vinyl fluoride and homopolymers and copolymers of vinylidene fluoride comprising at least 60 mole % vinylidene fluoride. In a more specific embodiment, the fluoropolymer is selected from homopolymers and copolymers of vinyl fluoride comprising at least 80 mole % vinyl fluoride and homopolymers and copolymers of vinylidene fluoride comprising at least 80 mole % vinylidene fluoride. Blends of the fluoropolymers with non-fluoropolymers, e.g., acrylic polymers, may also be suitable for the practice of some aspects of the invention. Homopolymer polyvinyl fluoride (PVF) and homopolymer polyvinylidene fluoride (PVDF) are well suited for the practice of specific aspects of the invention. Fluoropolymers selected from homopolymer polyvinyl fluoride and copolymers of vinyl fluoride are particularly effective for the practice of the present invention.

In one embodiment, with VF copolymers or VDF copolymers, comonomers can be either fluorinated or nonfluorinated or combinations thereof. By the term “copolymers” is meant copolymers of VF or VDF with any number of additional fluorinated or non-fluorinated monomer units so as to form dipolymers, terpolymers, tetrapolymers, etc. If nonfluorinated monomers are used, the amount used should be limited so that the copolymer retains the desirable properties of the fluoropolymer, i.e., weather resistance, solvent resistance, barrier properties, etc. In one embodiment, fluorinated comonomers are used including fluoroolefins, fluorinated vinyl ethers, or fluorinated dioxoles. Examples of useful fluorinated comonomers include tetrafluoroethylene (TFE), hexafluoropropylene (HFP), chlorotrifluoroethylene (CTFE), trifluoroethylene, hexafluoroisobutylene, perfluorobutyl ethylene, perfluoro (propyl vinyl ether) (PPVE), perfluoro (ethyl vinyl ether) (PEVE), perfluoro (methyl vinyl ether) (PMVE), perfluoro-2,2-dimethyl-1,3-dioxole (PDD) and perfluoro-2-methylene-4-methyl-1,3-dioxolane (PMD) among many others.

Homopolymer PVDF coatings can be formed from a high molecular weight PVDF. Blends of PVDF and alkyl (meth)acrylate polymers can be used. Polymethyl methacrylate is particularly desirable. Typically, these blends can comprise 50-90% by weight of PVDF and 10-50% by weight of alkyl (meth)acrylate polymers, in a specific embodiment, polymethyl methacrylate. Such blends may contain compatibilizers and other additives to stabilize the blend. Such blends of polyvinylidene fluoride, or vinylidene fluoride copolymer, and acrylic resin as the principal components are described in U.S. Pat. Nos. 3,524,906; 4,931,324; and 5,707,697.

Homopolymer PVF coatings can be formed from a high molecular weight PVF. Suitable VF copolymers are taught by U.S. Pat. Nos. 6,242,547 and 6,403,740 to Uschold.

### Light Stabilizers

In one embodiment, a liquid fluoropolymer coating compositions may contain one or more light stabilizers. Light stabilizer include compounds that absorb ultraviolet radiation such as hydroxybenzophenones, hydroxyphenyl-triazines (HPT) and hydroxybenzotriazoles. For example, a hydroxyphenyl-triazine may include 2-hydroxyphenyl-s-triazine (Tinuvin® 479, BASF Corporation, Wyandotte, Mich.). In one embodiment, light stabilizers include hindered amine light stabilizers (HALS), such as a combination of bis(1,2,2,6,6-pentamethy-4-piperidyl) sebacate and methyl 1,2,2,6,6-pentamethyl-4-piperidyl sebacate (e.g., Tinuvin® 292, BASF Corporation). In one embodiment, a light stabilizer is present in a range of from about 0.5 to about 15.0 part per hundred (pph) based on fluoropolymer resin solids, or from about 1.0 to about 12.0 pph.

In one embodiment, a light stabilizer can include both a UV absorber and a HALS, such as a combination of Tinuvin® 479 and Tinuvin® 292. In a specific embodiment a ratio of UV absorber to HALS is in a range of from about 1:1 to about 4:1, or from about 1.5:1 to about 2:1.

### Compatible Adhesive Polymers and Cross-Linking Agents

Compatible adhesive polymers employed in the fluoropolymer coated film according to one aspect of the invention comprise functional groups selected from amine, isocyanate, hydroxyl and combinations thereof. In one embodiment, the compatible adhesive polymer has (1) a backbone composition that is compatible with the fluoropolymer in the composition and (2) pendant functionality capable of reacting with complementary functional groups on a substrate film surface. The compatibility of the adhesive polymer backbone with the fluoropolymer will vary but is sufficient so that the compatible adhesive polymer can be introduced into the fluoropolymer in the desired amount to secure the fluoropolymer coating to the polymeric substrate film. In general however, homo and copolymers derived largely from vinyl fluoride and vinylidene fluoride will show compatibility characteristics that will favor acrylic, urethane, aliphatic polyester, polyester urethane, polyether, ethylene vinyl alcohol copolymer, amide, acrylamide, urea and polycarbonate backbones having the functional groups described above.

In a specific embodiment, where the polymeric substrate film is an unmodified polyester with intrinsic hydroxyl and carboxylic acid functional groups (e.g., adventitious surface groups or chain ends), reactive polyols (e.g., polyester polyols, polycarbonate polyols, acrylic polyols, polyether polyols, etc.) can be used as the compatible adhesive polymer in the presence of an appropriate cross-linking agent (e.g., an isocyanate functional compound or a blocked isocyanate functional compound) to bond the fluoropolymer coating to the polymeric substrate film. The bonding may occur through the functional groups of the reactive polyols, the cross-linking agent, or both. Upon curing, a cross-linked adhesive polymer, such as a cross-linked polyurethane network is formed as an interpenetrating network with the fluoropolymer in the coating. In addition, it is believed that the cross-linked polyurethane network also provides the functionality that bonds the fluoropolymer coating to the polyester substrate film.

Those skilled in the art will understand that choices for compatible adhesive polymers and cross-linking agents can be based on compatibility with the fluoropolymer, compatibility with the selected fluoropolymer solution or dispersion, their compatibility with the processing conditions for forming the fluoropolymer coating on the selected polymeric substrate film, their ability to form cross-linked networks during formation of the fluoropolymer coating, and/or the compatibility of their functional groups with those of the polymeric substrate film in forming bonds that provide strong adherence between the fluoropolymer coating and the polymeric substrate film.

### Catalyst Systems

Addition of a suitable catalyst system can accelerate the rate of reaction in order to achieve a commercially viable process. In one embodiment, a catalyst may be an organotin compound. Examples of suitable organotin compounds include dibutyl tin dilaurate (DBTDL), dibutyl tin dichloride, stannous octanoate, dibutyl tin dilaurylmercaptide and dibutyltin diisooctylmaleate.

In one embodiment, the catalyst is a mixed catalyst. The term “mixed catalyst” when used herein, refers to a catalyst system in which at least two different compounds act as catalysts for chemical reaction in a single system. In one embodiment of a mixed catalyst system, a main catalyst may be an organotin compound, and a co-catalyst may be selected from the group consisting of organozincs, organobismuths, and mixtures thereof. Suitable organotin compounds include, but are not limited to, dibutyl tin dilaurate (DBTDL), dibutyl tin dichloride, stannous octanoate, dibutyl tin dilaurylmercaptide and dibutyltin diisooctylmaleate.

In one embodiment, wherein the co-catalyst includes an organozinc compound, the co-catalyst can include a zinc carboxylate or an organozinc acetylacetone complex. Examples of suitable organozinc compounds include zinc acetylacetonate, zinc neodecanoate, zinc octanoate and zinc oleate. Suitable organozinc compounds also include BiCAT® 3228 and BiCAT® Z (both available from The Shepherd Chemical Co., Norwood, Ohio).

In another embodiment, wherein the co-catalyst includes an organobismuth compound, the co-catalyst can include an organobismuth carboxylate complex. Examples of suitable organobismuth compounds include K-KAT 348 and K-KAT 628 (King Industries, Inc. Norwalk, Conn.), and BiCAT® 8, BiCAT® 8106, BiCAT® 8108 and BiCAT® 8210 (all available from Shepherd Chemical).

Numerous combinations of organotin catalysts with co-catalysts comprising organozincs, organobismuths, and mixtures thereof may be useful in the liquid fluoropolymer coating compositions described herein. Those skilled in the art will be able to select an appropriate mixed catalyst system based on the properties of the polymer system being used in the process and the desired properties of the final fluoropolymer coated film.

### Pigments and Fillers

If desired, various color, opacity and/or other property effects can be achieved by incorporating pigments and fillers into the fluoropolymer coating composition dispersion during manufacture. Pigments preferably are used in amounts of about 1 to about 35 wt % based on fluoropolymer solids. Typical pigments that can be used include both clear pigments, such as inorganic siliceous pigments (silica pigments, for example) and conventional pigments. Conventional pigments that can be used include metallic oxides such as titanium dioxide, and iron oxide; metal hydroxides; metal flakes, such as aluminum flake; chromates, such as lead chromate; sulfides; sulfates; carbonates; carbon black; silica; talc; china clay; phthalocyanine blues and greens, organo reds; organo maroons and other organic pigments and dyes. Preferred are pigments that are stable at high temperatures during processing. It is also preferable that the type and amount of pigment is selected to prevent any significant adverse effects on the desirable properties of the fluoropolymer coating, e.g., weatherability and transparency.

Pigments can be formulated into a millbase by mixing the pigments with a dispersing resin that may be the same as or compatible with the fluoropolymer composition into which the pigment is to be incorporated. Pigment dispersions can be formed by conventional means, such as sand grinding, ball milling, attritor grinding or two-roll milling. Other additives, while not generally needed or used, such as fiber glass and mineral fillers, anti-slip agents, plasticizers, nucleating agents, and the like, can be incorporated. In one embodiment, thermal stabilizers (e.g., triphenyl phosphite) can also be used.

### Barrier Particles

In one embodiment, the fluoropolymer coating composition may include barrier particles. In a specific embodiment, the particles may be platelet-shaped particles. Such particles tend to align during application of the coating and, since water, solvent and gases such as oxygen cannot pass readily through the particles themselves, a mechanical barrier is formed in the resulting coating which reduces permeation of water, solvent and gases. In a photovoltaic module, for example, the barrier particles substantially increase the moisture barrier properties of the fluoropolymer and enhance the protection provided to the solar cells. In some embodiments, barrier particles are present in amounts of from about 0.5 to about 10% by weight based on the total dry weight of the fluoropolymer resin solids in the coating.

Examples of typical platelet shaped filler particles include mica, talc, clay, glass flake, stainless steel flake and aluminum flake. In one embodiment, the platelet shaped particles are mica particles, including mica particles coated with an oxide layer such as iron or titanium oxide. In some embodiments, these particles have an average particle size of about 10 to 200 μm, or 20 to 100 μm, with no more than 50% of the particles of flake having average particle size of more than about 300 μm. The mica particles coated with an oxide layer are described in U.S. Pat. No. 3,087,827 (Klenke and Stratton); U.S. Pat. No. 3,087,828 (Linton); and U.S. Pat. No. 3,087,829 (Linton). The micas described in these patents are coated with oxides or hydrous oxides of titanium, zirconium, aluminum, zinc, antimony, tin, iron, copper, nickel, cobalt, chromium, or vanadium. Mixtures of coated micas can also be used. It is also preferable that the type and amount of barrier particle is selected to prevent any significant adverse effects on the desirable properties of the fluoropolymer coating, e.g., weatherability and transparency.

### Liquid Fluoropolymer Coating Compositions

Liquid fluoropolymer coating compositions may contain the fluoropolymer either in the form of a solution or dispersion of the fluoropolymer. Typical solutions or dispersions for the fluoropolymer are prepared using solvents which have boiling points high enough to avoid bubble formation during the film forming/drying process. For polymers in dispersion form, a solvent which aids in coalescence of the fluoropolymer is desirable. The polymer concentration in these solutions or dispersions is adjusted to achieve a workable viscosity of the solution and will vary with the particular polymer, the other components of the coating composition, and the process equipment and conditions used. In one embodiment, for solutions, the fluoropolymer is present in an amount of about 10 wt % to about 25 wt % based on the total weight of the liquid fluoropolymer coating composition. In another embodiment, for dispersions, the fluoropolymer is present in an amount of about 25 wt % to about 50 wt % based on the total weight of the liquid fluoropolymer coating composition.

The form of the polymer in the liquid fluoropolymer coating composition is dependent upon the type of fluoropolymer and the solvent used. Homopolymer PVF is normally in dispersion form. Homopolymer

PVDF can be in dispersion or solution form dependent upon the solvent selected. For example, homopolymer PVDF can form stable solutions at room temperature in many polar organic solvents such as amides, ketones, esters and some ethers. Suitable examples include acetone, methylethyl ketone (MEK), N-methyl pyrrolidone (NMP), dimethyl acetamide (DMAC), and tetrahydrofuran (THF). Depending upon comonomer content and the solvent selected, copolymers of VF and VDF may be used either in dispersion or solution form.

In one embodiment, using homopolymer polyvinyl fluoride (PVF), suitable coating formulations are prepared using dispersions of the fluoropolymer. The nature and preparation of dispersions are described in detail in U.S. Pat. Nos. 2,419,008; 2,510,783; and 2,599,300. In a specific embodiment, PVF dispersions are formed in propylene carbonate (PC), γ-butyrolactone (GBL), NMP, DMAC or dimethylsulfoxide (DMSO). In addition, these dispersions may contain co-solvents, such as BEA, PMA or others to facilitate the coating process.

To prepare the liquid fluoropolymer coating composition in dispersion form, the fluoropolymer may be milled in a suitable solvent, followed by the addition of the compatible adhesive polymer, the cross-linking agent, the catalyst and any other components that may be used in the coating composition. Components which are soluble in the solvent do not require milling.

A wide variety of mills can be used for the preparation fluoropolymer dispersions. Typically, the mill employs a dense agitated grinding medium, such as sand, steel shot, glass beads, ceramic shot, Zirconia, or pebbles, as in a ball mill, an ATTRITOR® available from Union Process, Akron, Ohio, or an agitated media mill such as a “Netzsch” mill available from Netzsch, Inc., Exton, Pa. The fluoropolymer dispersion is milled for a time sufficient to cause de-agglomeration of the PVF particles. Typical residence time of the dispersion in a Netzsch mill ranges from thirty seconds up to ten minutes. Milling conditions of the fluoropolymer dispersion (e.g., temperature) are controlled to avoid swelling or gelation of the fluoropolymer particles.

The compatible adhesive polymer is employed in the liquid fluoropolymer coating composition at a level sufficient to provide the desired bonding to the polymeric substrate film but below the level at which the desirable properties of the fluoropolymer would be significantly adversely affected. In one embodiment, the liquid fluoropolymer coating composition contains from about 1 to about 40 wt % compatible adhesive polymer, or from about 1 to about 25 wt %, or from about 1 to about 20 wt %, based on the weight of the fluoropolymer.

The cross-linking agent is employed in the liquid fluoropolymer coating composition at a level sufficient to provide the desired cross-linking of the compatible adhesive polymer. In one embodiment, the liquid coating composition contains from about 50 to about 400 mole % cross-linking agent per molar equivalent of compatible adhesive polymer, or from about 75 to about 200 mole %, or from about 125 to about 175 mole %.

Catalyst may be employed in the liquid coating fluoropolymer composition to improve the process kinetics. The amount of catalyst used is typically kept to a minimum to limit any negative effects on long term adhesion between polymeric substrate films and fluoropolymer coatings formed using the liquid coating composition. In one embodiment, an organotin catalyst may be used and can be present in a range of from about 0.005 to about 0.5 parts per hundred (pph), dry basis, of catalyst to fluoropolymer resin solids, or from about 0.01 to about 0.05 pph, or from about 0.01 to about 0.02 pph.

In one embodiment, a mixed catalyst system can be used. When incorporating a mixed catalyst into the liquid fluoropolymer coating composition, an organotin catalyst can be used as a main catalyst, and can be present in a range of from about 0.005 to about 0.1 parts per hundred (pph), dry basis, of main catalyst to fluoropolymer resin solids, or from about 0.01 to about 0.05 pph, or from about 0.01 to about 0.02 pph. In one embodiment, the co-catalyst can be an organobismuth compound or an organozinc compound and can be present in a range of from about 0.05 to about 1.0 pph, dry basis, of co-catalyst to fluoropolymer resin solids, or from about 0.1 to about 0.5 pph, or from about 0.1 to about 0.2 pph.

The solids weight ratio of main catalyst to co-catalyst used in a mixed catalyst system can vary over a broad range. In one embodiment, the solids weight ratio of main catalyst to co-catalyst can be in a range of from about 0.005:1 to about 200:1, or from about 0.05:1 to about 50:1, or from about 0.1:1 to about 2:1.

The amount of catalyst used, and in the case of a mixed catalyst system, the solids weight ratio of main catalyst to co-catalyst in the mixed catalyst, will affect the cure time needed to produce good adhesion of a fluoropolymer coating to a polymeric substrate film.

In one embodiment, a liquid fluoropolymer coating compositions may have an overall solids content in the range of from about 10 to about 60 weight percent, or from about 20 to about 50 weight percent, or from about 30 to about 45 weight percent. The term “overall solids content” when used herein is expressed as a weight percentage of the dry solids in the coating composition relative to the overall weight of the liquid fluoropolymer coating compositions (including both wet and dry components).

### Polymeric Substrate Films

Polymeric substrate films may be selected from a wide range of polymers, with thermoplastics being desirable for their ability to withstand higher processing temperatures. The polymeric substrate film comprises functional groups on its surface that interact with the compatible adhesive polymer, the cross-linking agent, or both, to promote bonding of the fluoropolymer coating to the polymeric substrate film. In one embodiment, the polymeric substrate film is a polyester, a polyamide, a polyimide, a polyolefin or a polycarbonate. In a specific embodiment, a polyester for the polymeric substrate film is selected from polyethylene terephthalate, polyethylene naphthalate, polybutylene terephthalate, and a co-extrudate of polyethylene terephthalate/polyethylene naphthalate.

Fillers may also be included in the substrate film, where their presence may improve the physical properties of the substrate, for example, higher modulus and tensile strength. They may also improve adhesion of the fluoropolymer coating to the polymeric substrate film. One exemplary filler is barium sulfate, although others may also be used.

The surface of the polymeric substrate film which is to be coated may naturally possess some functional groups suitable for bonding, as in hydroxyl and/or carboxylic acid groups in a polyester film, or amine and/or acid functionality in a polyamide film. The presence of these intrinsic functional groups on the surface of a polymeric substrate film clearly provide commercial benefits by simplifying the process of bonding a coating onto the polymeric substrate film to form a fluoropolymer coated film. The invention employs compatible adhesive polymers and/or cross-linking agents in the coating composition that may take advantage of the intrinsic functionality of the polymeric substrate film. In this way, an unmodified polymeric substrate film can be chemically bonded to a fluoropolymer coating (i.e., without the use of separate primer layers or adhesives or separate surface activation treatments) to form a fluoropolymer coated film with excellent adhesion. The term “unmodified polymeric substrate film” as used herein means polymeric substrates which do not include primer layers or adhesives and which do not include surface treatment or surface activation such as are described in the following paragraph. In addition, an unprimed polymeric substrate film can be chemically bonded to a fluoropolymer coating to form a fluoropolymer coated film with excellent adhesion. The term “unprimed polymeric substrate film” as used herein means polymeric substrates which do not include primer layers but may include surface treatment or surface activation such as are described in the following paragraph.

Many polymeric substrate films may need or would further benefit from modifying to provide additional functional groups suitable for bonding to the fluoropolymer coating, however, and this may be achieved by surface treatment, or surface activation. That is, the surface can be made more active by forming functional groups of carboxylic acid, sulfonic acid, aziridine, amine, isocyanate, melamine, epoxy, hydroxyl, anhydride and/or combinations thereof on the surface. In one embodiment, the surface activation can be achieved by chemical exposure, such as to a gaseous Lewis acid such as BF₃ or to sulfuric acid or to hot sodium hydroxide. Alternatively, the surface can be activated by exposing one or both surfaces to an open flame while cooling the opposite surface. Surface activation can also be achieved by subjecting the film to a high frequency, spark discharge such as corona treatment or atmospheric nitrogen plasma treatment. Additionally, surface activation can be achieved by incorporating compatible comonomers into the polymeric substrate when forming a film. Those skilled in the art, will appreciate the wide variety of processes that may be used to form compatible functional groups on the surface of a polymeric substrate film.

In addition, modifying to provide additional functional groups suitable for bonding to the fluoropolymer coating may be performed by applying a primer layer to the surface of the polymeric substrate film to increase its surface functionality. In one embodiment, a polymeric substrate may have a thickness in the range of from about 12.5 μm (0.5 mil) and 250 μm (10 mil).

### Coating Application

The fluoropolymer compositions for making the fluoropolymer coated film in accordance with one aspect of the present invention can be applied as a liquid directly to suitable polymeric substrate films by conventional coating means with no need to form a preformed film. Techniques for producing such coatings include conventional methods of casting, dipping, spraying and painting. When the fluoropolymer coating contains fluoropolymer in dispersion form, it is typically applied by casting the dispersion onto the substrate film, using conventional means, such as spray, roll, knife, curtain, gravure coaters, slot-die or any other method that permits the application of a uniform coating without streaks or other defects. In one embodiment, the dry coating thickness of a cast dispersion is between about 2.5 μm (0.1 mil) and about 75 μm (3 mil), in a more specific embodiment, between about 4 μm (0.16 mil) and about 50 μm (2 mil), and in a still more specific embodiment, between about 6 μm (0.24 mil) and about 25 μm (1 mil).

After application, the compatible adhesive polymer is cross-linked, the solvent is removed, and the fluoropolymer coating is adhered to the polymeric substrate film. With some compositions in which the fluoropolymer is in solution form, the liquid fluoropolymer coating compositions can be coated onto polymeric substrate films and allowed to air dry at ambient temperatures. Although not necessary to produce a coalesced film, heating is generally desirable to cross-link the compatible adhesive polymer and to dry the fluoropolymer coating more quickly. Cross-linking the compatible adhesive polymer, removing of the solvent, and adhering of the fluoropolymer coating to the polymeric substrate can be achieved in a single heating or by multiple heatings. Drying temperatures are in the range of about 25° C. (ambient conditions) to about 220° C. (oven temperature—the film temperature may be lower). The temperature used should also be sufficient to promote the interaction of the functional groups in the compatible adhesive polymer and/or cross-linking agent with the functional groups of the polymeric substrate film to provide secure bonding of the fluoropolymer coating to the polymeric substrate film. This temperature varies widely with the compatible adhesive polymer and cross-linking agent employed and the functional groups of substrate film. The drying temperature can range from room temperature to oven temperatures in excess of that required for the coalescence of fluoropolymers in dispersion form as discussed below.

When the fluoropolymer in the composition is in dispersion form, it is necessary for the solvent to be removed, for cross-linking of the compatible adhesive polymer to occur, and also for the fluoropolymer to be heated to a sufficiently high temperature that the fluoropolymer particles coalesce into a continuous film. In addition, bonding to the polymeric substrate film is desired. In one embodiment, fluoropolymer in the coating is heated to a cure temperature of about 150° C. to about 250° C. The solvent used desirably aids in coalescence, i.e., enables a lower temperature to be used for coalescence of the fluoropolymer coating than would be necessary with no solvent present. Thus, the conditions used to coalesce the fluoropolymer will vary with the fluoropolymer used, the solvent chosen, the thickness of the cast dispersion and the substrate film, and other operating conditions. For homopolymer PVF coatings and residence times of about 1 to about 3 minutes, oven temperatures of from about 340° F. (171° C.) to about 480° F. (249° C.) can be used to coalesce the film, and temperatures of about 380° F. (193° C.) to about 450° F. (232° C.) have been found to be particularly satisfactory. The oven air temperatures, of course, may not be representative of the temperatures reached by the fluoropolymer coating which may be lower.

Formation of a cross-linked network of compatible adhesive polymer in the presence of the coalescing fluoropolymer can result in the formation of interpenetrating networks of compatible adhesive polymer and fluoropolymer, creating an interlocked network. Thus, even if there is segregation or phase separation of the two polymer networks within the fluoropolymer coating and an absence of chemical bonding between the two networks, a strong durable coating is still formed. As long as there is adequate bonding between the compatible adhesive polymer and the polymeric substrate film, excellent adhesion between the layers of the fluoropolymer coated film can be attained.

The fluoropolymer coating composition is applied to a polymeric substrate film. In one embodiment, the polymeric substrate film is polyester, polyamide, or polyimide. In a specific embodiment, the polymeric substrate film is polyester such as polyethylene terephthalate, polyethylene naphthalate or a co-extrudate of polyethylene terephthalate/polyethylene naphthalate. In another embodiment, the fluoropolymer coating is applied to both surfaces of the substrate film. This can be performed simultaneously on both sides of the polymeric substrate film or alternatively, the coated substrate film can be dried, turned to the uncoated side and resubmitted to the same coating head to apply coating to the opposite side of the film to achieve coating on both sides of the film.

### Transparent Fluoropolymer Coated Films

Transparent fluoropolymer coated film can be used in outdoor applications, such as building structures (e.g., greenhouses, roofing, siding, awnings, windows, etc.), signage, wall coverings, etc., as well as indoor applications where they may be exposed to sunlight. In one embodiment, a transparent fluoropolymer coated film has a transmission of at least 75 percent in the visible range. In a specific embodiment, a transparent fluoropolymer coated film has a transmission of at least 85 percent in the visible range. The term “visible range” when used herein, refers to the portion of the electromagnetic spectrum that is visible to the typical human eye, ranging in wavelength from about 400 to about 700 nm. A percent transmission over a range of wavelengths can be taken as a summation over the range (i.e., integration under a curve of wavelength plotted against percent transmission).

While maintaining good transmission in the visible range, a transparent fluoropolymer coated film may also block harmful UV light that can degrade polymeric substrate films. In one embodiment, after 700 hours of ASTM G155, Cycle 1 weathering testing (described below), a transparent fluoropolymer coated film has a transmission of less than 10 percent at 340 nm, or less than 5 percent. In one embodiment, after 2400 hours of ASTM G155, Cycle 1 weathering testing, a transparent fluoropolymer coated film has a transmission of less than 10 percent at 340 nm, or less than 5 percent.

### Examples

The concepts described herein will be further described in the following examples, which do not limit the scope of the invention described in the claims.

### Test Methods

### UV-Vis Transmission Test

Samples were cut into 2.6×5.5 inch samples in preparation for Xenon Weathering Exposure Testing. Each film sample was analyzed for initial UV-Vis transmission using a Lambda 650 UV-Vis Spectrophotometer (PerkinElmer, Waltham, Mass.), making sure that the fluoropolymer coated side was facing away from the sample holder. UV-Vis transmission spectra were measured from 250 to 900 nm. After each sample was measured for initial UV-Vis transmission, samples were subjected to ASTM G155 weathering testing at 0.55 W/m², using either Cycle 1 or Cycle 2 exposure conditions for a specified amount of time. For Cycle 1 testing, samples are exposed to 340 nm light for 102 minutes at a back panel temperature of 63° C. followed by an 18 minute exposure with the same light plus a water spray. This exposure pattern is then repeated continuously for the desired number of hours. For Cycle 2 testing, the Cycle 1 exposure pattern is repeated nine times for a total of 18 hours, followed by 6 hours of dark (no irradiance), maintaining the back panel temperature of 63° C., with this pattern of 18 hours exposure and 6 hours dark repeated continuously for the desired number of hours.

### Mechanical Properties

Mechanical properties are measured using an Instron® Model 3365 Dual Column Testing System (Instron, Norwood, Mass.). Elongation at break and tensile stress at peak are measured using ASTM Method D882 for both the as-made, cured film (initial) and after ASTM G155 weathering testing, using either Cycle 1 or Cycle 2 exposure conditions. Samples were prepared for analysis at 0.25″ wide with a 2″ gauge length and ran at a crosshead speed of 2″ per minute.

### Examples 1-4 and Comparative Example 1

For Comparative Example 1 (CE1), a liquid fluoropolymer coating composition was made from 6117 g of a 45 wt % solids dispersion of PVF in propylene carbonate. To this was added, with stirring, 63 g of a 100 wt % solution of Desmophen® C-3100 (Bayer Materials Science, Pittsburgh, Pa.), 74 g of Desmodur® PL-350 (Bayer Materials Science), and a mixed catalyst system. The mixed catalyst system was added as 8.4 g of a main catalyst solution (1 g dibutyl tin dilaurate (DBTDL) and 10 g acetic acid), and 7.5 g of a bismuth 2-ethylhexanoic acid co-catalyst (K-KAT 348, King Industries). The resulting coating composition had 0.03 pph DBTDL and 0.27 pph K-KAT 348 based on parts per hundred (pph) fluoropolymer resin solids.

The coating compositions was stirred for 2 minutes, and then coated using a reverse gravure coating process on polyester (2 mil corona treated SG00, SKC Inc., Covington, Ga.) and cured at 204° C. for 60 seconds, resulting in a 1 mil (25.4 μm) dry coating thickness. The dried film could not be peeled off of the polyester.

For Examples 1-4, a 200 g solution of 2-hydroxyphenyl-s-triazine (Tinuvin® 479, BASF Corporation, Wyandotte, Mich.) was made by adding 57.2 g of Tinuvin® 479 to 142.8 g of butoxy ethyl acetate (BEA, butyl CELLOSOLVE™ acetate, Dow Chemical Co., Midland, Mich.).

For Example 1 (E1), a liquid fluoropolymer coating composition was made using 6000 g of the liquid fluoropolymer coating composition made in CE1. To this, with stirring, was added 29 g of the Tinuvin® 479 solution and 4.8 g of Tinuvin® 292 (BASF Corporation). The resulting coating composition had 0.32 pph Tinuvin® 479 and 0.18 pph Tinuvin® 292 based on parts per hundred (pph) fluoropolymer resin solids. A coating was made on polyester as in CE1. The dried film could not be peeled off of the polyester.

For Example 2 (E2), a liquid fluoropolymer coating composition was made using 5900 g of the liquid fluoropolymer coating composition made in E1. To this, with stirring, was added 28 g of the Tinuvin® 479 solution and 4.7 g of Tinuvin® 292. The resulting coating composition had 0.62 pph Tinuvin® 479 and 0.37 pph Tinuvin® 292 based on parts per hundred (pph) fluoropolymer resin solids. A coating was made on polyester as in CE1. The dried film could not be peeled off of the polyester.

For Example 3 (E3), a liquid fluoropolymer coating composition was made using 5800 g of the liquid fluoropolymer coating composition made in E2. To this, with stirring, was added 28 g of the Tinuvin® 479 solution and 4.6 g of Tinuvin® 292. The resulting coating composition had 0.95 pph Tinuvin® 479 and 0.56 pph Tinuvin® 292 based on parts per hundred (pph) fluoropolymer resin solids. A coating was made on polyester as in CE1. The dried film could not be peeled off of the polyester.

For Example 4 (E4), a liquid fluoropolymer coating composition was made from 5700 g of the liquid fluoropolymer coating composition made in E3. To this, with stirring, was added 27 g of the Tinuvin® 479 solution and 4.5 g of Tinuvin® 292. The resulting coating composition had 1.26 pph Tinuvin® 479 and 0.75 pph Tinuvin® 292 based on parts per hundred (pph) fluoropolymer resin solids. A coating was made on polyester as in CE1. The dried film could not be peeled off of the polyester.

Table 1 summarizes transmission data of the initial coating samples, the samples after 1000 hours of weathering testing (Cycle 2) and the samples after 2000 hours of weathering testing (Cycle 2). The total exposure to 340 nm light during 1000 hours of Cycle 2 testing is 750 hours. Table 2 summarizes mechanical data of the initial coating samples and the samples after 2000 hours of weathering testing (Cycle 2). For these examples, elongation and tensile stress measurements were taken in the machine direction (MD). The coatings for E1-E4 and CE1 all had a 1 mil (25.4 μm) dry coating thickness.

TABLE 1

| | | | % T | % T | % T | % T | % T | % T |
|---|---|---|---|---|---|---|---|---|
| | HPT | HALS | 340 nm | 340 nm | 340 nm | visible | visible | visible |
| Example | (pph) | (pph) | (Initial) | (1000 hr) | (2000 hr) | (Initial) | (1000 hr) | (2000 hr) |
| CE1 | 0 | 0 | 78.6 | 50.5 | 39.0 | 88.6 | 87.9 | 85.4 |
| E1 | 0.32 | 0.18 | 14.9 | 44.2 | 43.1 | 88.2 | 81.7 | 86.1 |
| E2 | 0.62 | 0.37 | 4.7 | 9.1 | 37.1 | 88.0 | 87.9 | 86.0 |
| E3 | 0.95 | 0.56 | 1.0 | 2.0 | 7.4 | 87.4 | 87.6 | 86.6 |
| E4 | 1.26 | 0.75 | 0.8 | 0.7 | 0.5 | 87.1 | 87.1 | 86.6 |

TABLE 2

| | | | | Tensile | Tensile | Change in |
|---|---|---|---|---|---|---|
| | | | Change in | Stress @ | Stress @ | Tensile |
| | Elongation | Elongation | Elongation | Peak | Peak | Stress @ |
| | @ Break | @ Break | @ Break | (N/mm, | (N/mm, | Peak |
| Example | (Initial) | (2000 hr) | (2000 hr) | Initial) | 2000 hr) | (2000 hr) |
| CE1 | 108.6% | 1.4% | −98.7% | 13.7 | 3.1 | −77.4% |
| E1 | 98.8% | 1.8% | −98.2% | 13.6 | 4.7 | −65.4% |
| E2 | 90.5% | 2.2% | −97.6% | 13.4 | 5.0 | −62.7% |
| E3 | 99.6% | 64.1% | −35.6% | 13.4 | 11.0 | −17.9% |
| E4 | 93.3% | 91.6% | −1.8% | 13.0 | 12.6 | −3.1% |

E1-E4 demonstrate that good transmission in the visible range can be maintained over a range of light stabilizer concentrations. In addition, blocking of harmful UV radiation can be improved by increasing the amount of light stabilizer used.

### Examples 5-7

For Example 5 (E5), a liquid fluoropolymer coating composition was made in the manner of E1-E4, but with a higher concentration of both HPT and HALS. A coating was made on polyester as in CE1, but at a final dry coating thickness of 0.5 mil (12.5 μm). The dried film could not be peeled off of the polyester.

For Example 6 (E6), a liquid fluoropolymer coating composition was made with the same light stabilizer concentration as E5, but on a smaller, lab scale. A coating was made on polyester as in CE1, but using a slot bar drawdown instead of a reverse gravure coating process, with a final dry coating thickness of 0.5 mil (12.5 μm). The dried film could not be peeled off of the polyester.

Table 3 summarizes transmission data of the initial coating samples, the samples after 700 hours of weathering testing (Cycle 1) and the samples after 2416 hours of weathering testing (Cycle 1). Table 4 summarizes mechanical data of the initial coating samples and the samples after 2416 hours of weathering testing (Cycle 1). For these examples, elongation and tensile stress measurements were taken in both the machine direction (MD) and transverse direction (TD).

TABLE 3

| Example | E5 | E6 |
|---|---|---|
| HPT (pph) | 2.32 | 2.32 |
| HALS (pph) | 1.23 | 1.23 |
| % T 340 nm (Initial) | 0 | 0.4 |
| % T 340 nm (700 hrs) | 0.6 | 0.3 |
| % T 340 nm (2416 hrs) | 1.4 | 0 |
| % T visible (Initial) | 86.9 | 86.8 |
| % T visible (700 hrs) | 87.1 | 86.7 |
| % T visible (2416 hrs) | 86.8 | 86.8 |

TABLE 4

| Example | E5 | E6 |
|---|---|---|
| Elongation @ Break MD (Initial) | 199.5% | 151.9% |
| Elongation @ Break MD (2416 hr) | 153.1% | 156.8% |
| Change in Elongation @ Break MD (2416 hr) | −23.3% | 3.2% |
| Elongation @ Break TD (Initial) | 163.6% | 148.9% |
| Elongation @ Break TD (2416 hr) | 196.7% | 164.4% |
| Change in Elongation @ Break TD (2416 hr) | 20.2% | 10.4% |
| Tensile Stress @ Peak MD (N/mm, Initial) | 10.6 | 11.8 |
| Tensile Stress @ Peak MD (N/mm, 2416 hr) | 9.4 | 11.5 |
| Change in Tensile Stress @ Peak MD (2416 hr) | −11.3% | −2.5% |
| Tensile Stress @ Peak TD (N/mm, Initial) | 11.5 | 11.1 |
| Tensile Stress @ Peak TD (N/mm, 2416 hr) | 9.0 | 10.7 |
| Change in Tensile Stress @ Peak TD (2416 hr) | −21.7% | −3.6% |

For Example 7 (E7), a liquid fluoropolymer coating composition was made in the manner of E6, but with an even higher light stabilizer concentration. A coating was made on polyester as in CE1, but at a final dry coating thickness of 0.25 mil (6.25 μm). The dried film could not be peeled off of the polyester. Tables 5 and 6 summarize the optical and mechanical properties, respectively, for E7.

TABLE 5

| Example | E7 |
|---|---|
| HPT (pph) | 6.85 |
| HALS (pph) | 3.63 |
| % T 340 nm (Initial) | 0.5 |
| % T 340 nm (700 hrs) | 0.5 |
| % T 340 nm (2800 hrs) | 1.0 |
| % T visible (Initial) | 88.4 |
| % T visible (700 hrs) | 88.3 |
| % T visible (2800 hrs) | 87.2 |

TABLE 6

| Example | E7 |
|---|---|
| Elongation @ Break MD (Initial) | 180.0% |
| Elongation @ Break MD (2800 hr) | 180.9% |
| Change in Elongation @ Break MD (2800 hr) | 0.5% |
| Elongation @ Break TD (Initial) | 110.0% |
| Elongation @ Break TD (2800 hr) | 94.7% |
| Change in Elongation @ Break TD (2800 hr) | −13.9% |
| Tensile Stress @ Peak MD (N/mm, Initial) | 13.3 |
| Tensile Stress @ Peak MD (N/mm, 2800 hr) | 13.2 |
| Change in Tensile Stress @ Peak MD (2800 hr) | −0.8% |
| Tensile Stress @ Peak TD (N/mm, Initial) | 11.4 |
| Tensile Stress @ Peak TD (N/mm, 2800 hr) | 15.6 |
| Change in Tensile Stress @ Peak TD (2800 hr) | −36.8% |

E5-E7 demonstrate that with higher light stabilizer concentrations, thinner coatings can be used, while maintaining excellent optical and mechanical properties of the transparent film, even under the harsher weather testing exposure conditions of ASTM G155 Cycle 1.

Note that not all of the activities described above in the general description or the examples are required, that a portion of a specific activity may not be required, and one or more further activities may be performed in addition to those described. Still further, the order in which activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that one or more modifications or one or more other changes can be made without departing from the scope of the invention as set forth in the claims below. Accordingly, the specification and figures are to be regarded in an illustrative rather than a restrictive sense and any and all such modifications and other changes are intended to be included within the scope of invention.

Any one or more benefits, one or more other advantages, one or more solutions to one or more problems, or any combination thereof has been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all of the claims.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. Further, reference to values stated in ranges include each and every value within that range.

What is claimed is:

1. A transparent fluoropolymer coated film comprising:
a polymeric substrate film; and
a fluoropolymer coating on the polymeric substrate film, the fluoropolymer coating comprising:
fluoropolymer selected from homopolymers and copolymers of vinyl fluoride and homopolymers and copolymers of vinylidene fluoride blended with a compatible adhesive polymer comprising functional groups selected from carboxylic acid, sulfonic acid, aziridine, amine, isocyanate, melamine, epoxy, hydroxy, anhydride and mixtures thereof; and
a light stabilizer;
wherein the polymeric substrate film comprises functional groups on its surface that interact with the compatible adhesive polymer to promote bonding of the fluoropolymer coating to the polymeric substrate film, and the transparent fluoropolymer coated film has a transmission of at least 75 percent in the visible range.

2. The fluoropolymer coated film of claim 1, wherein the light stabilizer comprises a UV absorber, a hindered amine light stabilizer or a combination thereof.

3. The transparent fluoropolymer coated film of claim 2, wherein the UV absorber comprises 2-hydroxyphenyl-s-triazine.

4. The transparent fluoropolymer coated film of claim 2, wherein the hindered amine light stabilizer comprises a combination of bis(1,2,2,6,6-pentamethyl-4-piperidyl) sebacate and methyl 1,2,2,6,6-pentamethyl-4-piperidyl sebacate.

5. The transparent fluoropolymer coated film of claim 2, wherein:
the light stabilizer comprises a combination of a UV absorber and a hindered amine light stabilizer;
the UV absorber comprises 2-hydroxyphenyl-s-triazine; and
the hindered amine light stabilizer comprises a combination of bis(1,2,2,6,6-pentamethyl-4-piperidyl) sebacate and methyl 1,2,2,6,6-pentamethyl-4-piperidyl sebacate.

6. The transparent fluoropolymer coated film of claim 1, wherein the light stabilizer is present in a range of from about 0.5 to about 15.0 parts per hundred based on fluoropolymer resin solids.

7. The transparent fluoropolymer coated film of claim 6, wherein the light stabilizer is present in a range of from about 1.0 to about 12.0 parts per hundred based on fluoropolymer resin solids.

8. The transparent fluoropolymer coated film of claim 2, wherein a ratio of UV absorber to hindered amine light stabilizer is in a range of from about 1:1 to about 4:1.

9. The transparent fluoropolymer coated film of claim 8, wherein the ratio of UV absorber to hindered amine light stabilizer is in a range of from about 1.5:1 to about 2:1.

10. The transparent fluoropolymer coated film of claim 1, further comprising a mixed catalyst.

11. The transparent fluoropolymer coated film of claim 1, wherein the transparent fluoropolymer coated film has a transmission of at least 85 percent in the visible range.

12. The transparent fluoropolymer coated film of claim 1, wherein the transparent fluoropolymer coated film has a transmission of less than 10 percent at 340 nm after 700 hours of ASTM G155, Cycle 1 weathering testing.

13. The transparent fluoropolymer coated film of claim 12, wherein the transparent fluoropolymer coated film has a transmission of less than 10 percent at 340 nm after 2400 hours of ASTM G155, Cycle 1 weathering testing.

14. The transparent fluoropolymer coated film of claim 1, wherein the fluoropolymer coating has a dry thickness of from about 2.5 to about 75 μm.

15. The transparent fluoropolymer coated film of claim 14, wherein the fluoropolymer coating has a dry thickness of from about 6 to about 25 μm.

16. The transparent fluoropolymer coated film of claim 1, wherein the polymeric substrate film has a thickness of from about 12.5 to about 250 μm.

17. The transparent fluoropolymer coated film of claim 1, wherein the polymeric substrate film is a thermoplastic polyester.

18. The transparent fluoropolymer coated film of claim 1, wherein the fluoropolymer coating is a surface layer of the fluoropolymer coated film.

19. A building structure comprising a transparent fluoropolymer coated film, wherein the transparent fluoropolymer coated film comprises:
a polymeric substrate film; and
a fluoropolymer coating on the polymeric substrate film, the fluoropolymer coating comprising:
fluoropolymer selected from homopolymers and copolymers of vinyl fluoride and homopolymers and copolymers of vinylidene fluoride blended with a compatible adhesive polymer comprising functional groups selected from carboxylic acid, sulfonic acid, aziridine, amine, isocyanate, melamine, epoxy, hydroxy, anhydride and mixtures thereof; and
a light stabilizer;
wherein the polymeric substrate film comprises functional groups on its surface that interact with the compatible adhesive polymer to promote bonding of the fluoropolymer coating to the polymeric substrate film, and the transparent fluoropolymer coated film has a transmission of at least 75 percent in the visible range.

20. A liquid fluoropolymer coating composition comprising:
a fluoropolymer selected from homopolymers and copolymers of vinyl fluoride and homopolymers and copolymers of vinylidene fluoride;
a light stabilizer comprising a combination of a UV absorber and a hindered amine light stabilizer;
solvent;
a compatible cross-linkable adhesive polymer; and
a cross-linking agent.

21. The liquid fluoropolymer coating composition of claim 20, wherein:
the UV absorber comprises 2-hydroxyphenyl-s-triazine; and
the hindered amine light stabilizer comprises a combination of bis(1,2,2,6,6-pentamethyl-4-piperidyl) sebacate and methyl 1,2,2,6,6-pentamethyl-4-piperidyl sebacate.
